(19) United States
(12) Patent Application Publication
(10) Pub. No.: US 2007/0042848 A1
(43) Pub. Date: Feb. 22, 2007

(54) Anti back bend driving chain

(75) Inventor: Peter Grabmann, Hollenbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JOH. WINKLHOFER & SOHNE GMBH UND CO. KG, Munchen (DE)

(21) Appl. No.: 11/506,264

(22) Filed: Aug. 18, 2006

(30) Foreign Application Priority Data
Aug. 22, 2005 (EP) 05018184.1

(51) Int. Cl. F16G 1/28

(52) U.S. Cl. 474/202

(57) ABSTRACT

An anti back bend driving chain comprising alternating first and second chain links interconnected via a respective chain hinge and pivotable relative to one another about a chairs hinge axis. The driving chain comprises a resiliently lockable and/or unlockable locking means for stiffening or arresting the chain hinges at least temporarily. Also, an anti back bend chain drive used for driving automated gate or door drives and comprising such an anti back bend driving chain and at least one chain wheel.

### CROSS-REFERENCE TO RELATED APPLICATION

The present application claims the benefit of priority of European Patent Application No. 05 018 184.1 filed on Aug. 22, 2005. The entire text of the priority application is incorporated herein by reference in its entirety.

### FIELD OF THE DISCLOSURE

The present disclosure relates to an anti back bend driving chain comprising alternating first and second chain finks interconnected via a respective chain hinge and pivotable relative to one another about a chain hinge axis, and further comprising at least one means for stiffening or arresting the chain hinges at feast temporarily. The present disclosure additionally relates to an anti back bend chain drive, in particular for driving automated gate or door drives, comprising an anti back bend driving chain and at least one chain wheel for driving said anti back bend driving chain.

### BACKGROUND OF THE DISCLOSURE

A chain of the type in question is already described e.g. in DE 945 438 B. The compression rigid connector chain shown there is used especially in winches for operating floodgates and gate leaf and is provided with stiffening link plates, which are arranged on pins projecting outwards beyond the link plates, for this purpose. The stiffening fink plates comprise a longitudinal slot, through which they are guided on the projecting ends of two successive pins, and an end face contour which, in the stiffened condition of the chain, engages the end face of the adjoining stiffening link plate in a wedge-shaped configuration. Due to the longitudinal slot provided in the stiffening link plates, said link plates can be displaced in the direction of movement of the chain, the displacement being effected by guiding the chain round a driving pinion. The guiding of the chain round the driving pinion and the pulling apart of the guiding link plates on the driving pinion results in a stiffening of the chain. Ahead of and behind the driving pinion, the chain is guided between two respective rolls. This compression rigid connector chain only stiffens, when the stiffening link plates on both sides of the driving pinion have been displaced to the end positions defined by the longitudinal slot, i.e. the stiffening effect depends directly on the encompassment of the driving pinion by the plate link chain.

In addition to this compression rigid connector chain with stiffening link plates that are adapted to be displaced in the longitudinal direction of the chain, the prior art comprises a plurality of other varying structural designs for stiffening chains. DE 1 450 699 B9 discloses a chain comprising several rows of chain link plates which are arranged parallel to on another and which are interconnected by a hinge pin. A pressure transmitting plate with a laterally protruding projection is provided between the outer link plate and the inner link plate, the end faces of said projection being implemented as stop surfaces, whereby the chain stiffens in one direction, but remains flexible in the other direction. In addition, DE 735 715 B discloses a plate link chain in the case of which the pivotal movement of the chain finks about the chain hinges is limited by a halved cylindrical sleeve, which is arranged round a chain pin, and by suitable openings in the link plates. Also in this case, only a one-sided stiffening of functions is achieved, even if a plurality of different link plates and a further halved sleeve are used. Furthermore, DE 876 627 f3 discloses a stiffening of chains according to the zipper principle and DE 212 083 discloses the use of curved slots in the outer link plates and of pins of the inner link plates, which engage these slots.

Although part of the structural designs that have hitherto been used in the prior art proved to be very useful, their function is frequently limited, e.g. insofar as the chain can only be stiffened on one side thereof and/or has limited stiffening properties, and their technical implementation is intricate, so that there is still a need for a simple and effective anti back bend driving chain.

### SUMMARY OF THE DISCLOSURE

It is therefore the object of the present invention to provide an anti back bend driving chain of the type mentioned at the beginning, which allows the highest degree of unlimited stiffening as well as a structural design which is as simple as possible.

In order to achieve this, an anti back bend driving chain of the type in question is provided with the feature that the locking means is adapted to be locked and/or unlocked by pivoting the chain links relative to one another.

The advantage of this construction is to be seen in the simple structural design of a small number of components which are fixed by the locking means, whereby a substantially forcefree stiffening is made possible. In the locked condition, the chain hinges can be stiffened or arrested with respect to both pivoting directions of the chain hinge, whereby the driving chain can be supported reliably in itself and thrust can be transmitted without additional guidance through the chain links, e.g. for operating automated gate or door drives. In view of the fact that the stiffening or arresting of the chain hinges is effected by a resiliently lockable and/or unlockable locking means, this anti back bend driving chain also allows a rapid change of load between tensile stress and thrust stress. Such rapid changes of load are necessary e.g. in the case of an automatic drive for satisfying the safety aspects prescribed by the law. An automated gate or door drive must be able to execute an immediate change of load, when it impinges on an object, e.g. a person, so as to relieve the jammed object. The resiliently lockable and/or unlockable locking means has the additional advantage that it is acted upon by major forces only during the locking movement itself, whereas in the locked as well as in the fully open condition it is substantially forcefree.

According to an advantageous embodiment, the locking means can be implemented symmetrically with respect to the longitudinal axis of the chain in the direction of movement of the chain. Due to the symmetrical structural design, the locking means produces the same effect in both directions of the pivotal movement of the driving chain about the chain hinge axis, whereby the chain, which comprises chain links that are symmetrically implemented as well, can be installed independently of its orientation.

An advantageous embodiment is so conceived that the locking means is adapted to be locked and/or unlocked by pivoting the chain hinges relative to one another. This allows a very simple operative principle of the locking means, which necessitates, apart from the movement of the chain links about the chain hinge axis, no additional locking movement. The movement of the chain links causes a pivotal movement to the side, which takes place essentially at right angles to the longitudinal axis of the chain and which can be utilized by the locking means so as to stiffen or arrest the chain hinges. In addition, the lateral stiffening movement allows a transmission of the trust forces and of the tractive forces, which is effected essentially through the chain links interconnected by the chain hinge; hence, this transmission takes place irrespectively of whether or not the chain hinges are stiffened or moveable.

An expedient embodiment is so conceived that the locking means comprises a locking projection which is resiliently deformable during locking and/or locking. A locking projection which is movable in this way allows simple locking and/or unlocking of the locking means thus permitting, in cooperation with the counter bearing, a simple stiffening of the chain hinges.

For a providing a simple structural design of the locking means, such locking means can comprise a locking pin and a locking recess, the locking pin being adapted to be received in the locking recess. In combination with the resiliently deformable locking projection, the locking recess and the locking pin form an effective and reliable locking means in the case of which the locking pin is adapted to be received in the locking recess where it normally remains for arresting the chain hinges in the locked position.

An advantageous embodiment of the anti back bend driving chain is so conceived that each of the first chain links is provided with a locking recess on either end face in the direction of movement of the chain, with the locking recess being adapted to receive therein a locking pin, and with at least one locking projection, and that each of the second chain links is provided with at least one locking pin. The connection of the components of the locking means with the alternating chain links limits the number of components of the driving chain, the utilization of the end faces in the direction of movement of the chain, i.e. in the longitudinal direction of the chain, allowing a chain height which is determined by the chain links and their actual chain function, but not by the stiffening or the arresting of the chain hinges for forming the anti back bend driving chain. The locking recess is preferably implemented as a circular segment-shaped groove, the circular segment angle being smaller than 180°, preferably smaller than 1200. The locking pin can be implemented as a round, an elliptical or a circular segment-shaped locking pin, the radius of the curved engagement portion and of a round locking pin, respectively, being especially smaller than the radius of a locking recess which is implemented as a circular segment-shaped groove. Furthermore, a part of the locking recess can be defined by at least one portion of one or several locking projections. Other than in the case of the anti back bend chains known in the prior art, the end faces of the first chain links of the present embodiment are not in contact with one another, but they rest, independently of one another, on a locking pin.

According to another embodiment, each of the first chain links can be provided with a locking recess and at least one locking projection on a first end face in the direction of movement of the chain and with a locking pin on a second end face in the direction of movement of the chain, said locking pin fitting into the locking recess of a neighboring first chain link. This structural design allows all the elements of the locking means to be arranged exclusively on the first chain link. Hence, it is possible to use standard components for the second chain links, whereby the costs for the production of the anti back bend driving chain can be optimized.

According to a preferred embodiment, the locking projection and the locking pin can overlap in the locked condition. The overlapping mode of arrangement of the locking projection and of the locking pin allow the chain hinges to be reliably arrested. The distance between the chain hinge, which carries out the locking movement and which interconnects the first and second chain links, and the projecting outer edge of the locking projection is larger than the distance between the chain hinge and the outer side of the locked locking pin, which faces the chain hinge, i.e. the distance measured along the longitudinal axis of the chain. The sum of these distances is preferably smaller than the chain pitch, i.e. the distance between two neighboring hinge pins, but larger than the difference of the chain pitch and the width of the locking pin in the direction of movement of the chain. For locking and/or unlocking the locking means, the locking pin must slide over the resiliently deformable locking projection, whereby said locking projection will undergo a resilient deformation, and lockingly engage the locking recess behind the protruding locking projection. Due to the overlapping mode of arrangement of the locking projection and of the locking pin, a substantially positively held locking means is realized, which can, in principle, be loadfree in the locked as well as in the unlocked condition. In addition to a purely positive connection established by the overlapping mode of arrangement of one or several locking projections and of the locking pin, the present locking means can be fixed at its locked position with a supplementary frictional component.

In order to allow a simple structural design of the locking means, the locking projection, the locking recess and the locking pin can have longitudinal axes which extend parallel to the chain hinge axis. Such a simple structural design is the basis for an operationally simple locking means used for stiffening and/or arresting the chain hinges.

In accordance with an advantageous embodiment, the pivoting of the chain links for locking and/or unlocking the locking means can cause the locking recess and the locking pin to move relative to one another in a curved transverse movement relative to the longitudinal axis of the chain, the locking pin being adapted to be locked in and/or unlocked from the locking recess due to said transverse movement. In contrast to a longitudinal locking movement in the direction of the longitudinal axis of the chain, a lateral transverse movement of the locking means allows locking and/or unlocking of said locking means without an elongation of or a movement of the anti back bend driving chain in the direction of the longitudinal axis of the chain. The lateral transverse movement of the locking means takes place especially about the chain hinge axis, the tangent of the curved transverse movement during locking and/or unlocking of the locking means extending essentially at right angles to the longitudinal axis of the chain.

An advantageous embodiment is so conceived that the first chain links are implemented as inner chain links and that the second chain links are implemented as outer chain links. This simple structural design of the anti back bend driving chain comprising inner chain links and outer chain links allows the use of conventional devices and machines which are used for standard chains, whereby the workload on these machines can be increased and special devices for mounting the anti back bend driving chain can be dispensed with. Furthermore, the outer chain link can comprise two outer link plates, two hinge pins which extend through said outer link plates, and at least one locking pin. Such a simple structural design of the outer chain link with standard outer link plates and press fitted hinge pins allows the use of standard chain components which are also used in the case of other chains, whereby the costs of the components are reduced. Furthermore, the incorporation of the locking pin in the outer chain link allows said locking pin to be fastened when the chain link is being assembled, without necessitating an additional work step. It will also be of advantage when, in accordance with one embodiment of the invention, the locking pin extends between the outer link plates and is arranged centrally on said outer link plates, when seen in the direction of the longitudinal axis of the chain. This allows the locking pin, preferably a round locking pin, to be fastened on or in the two outer link plates, the locking pin being preferably arranged centrally in the direction of the longitudinal axis of the chain as well as throughout the width of the link plate, i.e. it is arranged on the link plate in a centered mode of arrangement.

In accordance with an advantageous embodiment, the inner chain link can comprise at least one inner link plate and the inner link plate can be provided with a locking recess and at least one locking projection. This particularly simple embodiment of the inner chain link also allows a simple arrangement of the elements of the locking means, especially on the end faces of the inner link plates in the direction of movement of the chain. In accordance with the above-described preferred embodiment of the locking means, the locking recess and the at least one locking projection are arranged at right angles to the longitudinal axis of the chain and axially parallel to the hinge pin. The locking means projects beyond at least one, preferably beyond both end faces of the inner link plates in the direction of movement of the chain, the flanks between the longitudinal edges, i.e. parallel to the longitudinal axis of the chain, being substantially straight or concave. The concave structural design of the flanks allows a small bend radius of the driving chain. A particularly narrow anti back bend chain can be realized by using a single inner link plate; this chain can be used in correspondingly narrow areas of use.

For a simple and economy-priced production, the at least one inner link plate can be produced from plastic material. The inner link plate can thus be formed integrally with a locking recess and at least one locking projection; at least in the area of the locking means resilient properties are provided, either by the plastic material itself or by suitable structural elements. An adequate permanent elasticity of the material and of the structural elements is here necessary for allowing a reliable operation during long operating times corresponding to a high number of locking and unlocking operations. In addition, also the use of a second plastic material for forming the elements of the locking means is possible; the different materials for the body of the inner link plate and for the locking means can be injected into a suitable mold in a two-component injection molding process.

In order to make the inner link plate sufficiently strong, the thickness of the inner link plate can, depending on the respective plastic material, correspond to 3 to 8 times the thickness of the outer link plate, preferably to 4 to 6 times the thickness of said outer link plate. In the case of a half-inch pitch of the anti back bend driving chain, the thickness of a single inner link plate is approx. 8 mm, which corresponds to the approximately 4.5 times the thickness of the outer link plate.

According to one variant, the locking means comprises at least one spring slot, said spring slot being formed in the first chain link and cooperating with the locking projection. Such a spring slot either establishes the resilience of the locking means in the first place or improves it. Used instead of a resilient material, or in addition to a resilient material, such a spring slot allows the resilient formability of the locking projection. As far as the movability of the locking projection is concerned, it will be especially advantageous to implement the spring slot as a longitudinal slot in the direction of the longitudinal axis of the chain, but, depending on the structural design of the locking means, also a lateral arrangement of the spring slots, in particular in the flank area of the inner link plate, will be suitable for establishing or improving the resilience of the locking means.

An advantageous embodiment is so conceived that each chain link comprises a hinge pin which extends through at least one hinge opening in the chain links, the hinge pin projecting on at least one side of the chain links for engagement with a chain wheel. In combination with the at least one hinge opening in the chain links, the hinge pin allows a pivoting of said chain links about the chain hinge axis. In the case of a flat structural design of the driving chain, the hinge pins can project beyond at least one side of the chain links for engagement with a suitably adapted chain wheel so as to drive the anti back bend chain in a simple manner. Furthermore, it is also possible that the hinge pin projects beyond the chain links on both sides and engages a suitably adapted more complex chain wheel, such a two-part chain wheel permitting the chain to be guided reliably between the individual gears of the chain wheel. In addition, an anti back bend driving chain according to the present disclosure can also be realized with driving possibilities that do not make use of projecting hinge pins, e.g. in the form of a roller chains.

The present disclosure additionally relates to an anti back bend chain drive, in particular for driving automated gate or door drives, comprising one of the above-described anti back bend driving chains and at least one chain wheel for driving said anti back bend driving chain. This chain drive according to the present disclosure allows thrust transmission through the chain without any additional lateral guide means in the case of automated gate or door drives. The locking means of the chain simultaneously allows a rapid change between thrust movement and tractive movement of the chain, whereby safety requirements during operation of automated gate or door drives can be fulfilled without the necessity of taking additional measures.

An expedient embodiment of the chain drive is so conceived that a guide means is provided for guiding and supporting the anti back bend driving chain at least during the locking and/or unlocking process. This guide means provides for the anti back bend driving chain a counter bearing for the force applied by the chain wheel for locking and/or unlocking. This counter bearing converts the rotary movement of the chain wheel into a pivotal movement of the chain hinge or into a transverse movement of the locking means for stiffening or arresting the chain hinges. The guide means can preferably have a length that corresponds to 1 to 3 times, in particular to approximately 2 times the chain pitch length, so as to guide and support the anti back bend driving chain to a sufficient extent. The guide means can be implemented as a guide rail, as a support that is provided on one side, or as a roll or a plurality of juxtaposed rolls; a support can be provided either in one or in both pivotal directions of the chain.

In order to allow the smallest possible dimensions of the anti back bend driving chain, the diameter of the chain wheel can be smaller than 4 times, preferably smaller than 3 times the chain pitch of the driving chain. Such a diameter of the chain wheel correlates with a correspondingly large bending radius between neighboring chain links. In the case of a chain pitch, i.e. hinge pin distance of approx. 12.7 mm, the chain wheel diameter can be approximately 38 mm, preferably even down to 30 mm. Depending on the structural design of the locking means of the first chain link and of the inner link plate, respectively, and on the bend radius, the flanks between the lateral edges and the projecting locking means must perhaps be implemented such that they are concave or provided with an opening.

### BRIEF DESCRIPTION OF THE DRAWINGS

In the following, one embodiment of the present disclosure will be explained in detail on the basis of the drawings, in which:

FIG. 1 shows a side view of an anti back bend chain according to the present disclosure, which is guided round a chain wheel;

FIG. 2 shows a top view, part of which is a sectional view through the anti back bend chain according to the present disclosure according to FIG. 1;

FIG. 3a shows a side view of the inner link plate of the anti back bend chain according to FIG. 1;

FIG. 3b shows a side view of a further embodiment of an inner link plate for use with the anti back bend chain according to FIG. 1;

FIG. 3c shows a side view of still another embodiment of the inner link plate for use with the anti back bend chain according to FIG. 1;

FIG. 3d shows aside view of an additional embodiment of an inner link plate for use with an anti back bend chain according to the present disclosure;

FIG. 4 shows another side view of the anti back bend chain according to the present disclosure shown in FIG. 1, in a condition in which said chain is wound round a chain wheel, the outer link plates in the area of the chain wheel being cut off.

### DETAILED DESCRIPTION OF THE DISCLOSURE

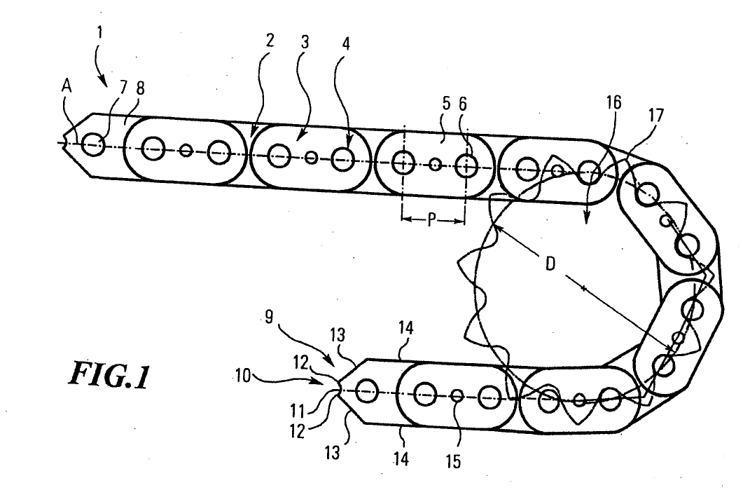

The anti back bend driving chain 1 shown in FIG. 1 comprises alternating inner chain links 2 and outer chain links 3. The inner chain links 2 and the outer chain links 3 are pivotably interconnected in alternating succession via respective chain hinges 4. The outer chain links 3 comprise two outer link plates 5 arranged in parallel spaced relationship with one another and interconnected via a hinge pin which extends perpendicular to said outer link plates 5. The hinge pins 6 extend at right angles to the longitudinal axis A of the chain through the outer link plates 5 and through the hinge opening 7 in the inner link plate 8 of the inner chain link 2.

The end face 9 of the inner link plate 8 in the direction of the longitudinal axis of the chain and the direction of movement of the anti back bend driving chain 1 is provided with a locking means 10 comprising a locking recess 11, which is arranged substantially centrally on said end face 9, and a locking projection 12 on either side of said locking recess 11. The locking projections 12 are followed by the end-face side flanks 13, which extend from the locking means 10 up to the lateral edges 14 of the inner link plate 8, said lateral edges 14 extending parallel to the longitudinal axis A of the chain.

The outer chain link 3 comprises in addition to the hinge pin 6 a locking pin 15, which extends through the two outer link plates 5 and between said outer link plates 5, without projecting on the outer side of said outer link plates 5. Also the locking pin 15 represents part of the locking means 10 and cooperates with the locking recess 11 and the locking projections 12 so as to stiffen or arrest the chain hinges 4. The center-to-center distance between the hinge pins 6 of the alternating inner and outer chain links 2, 3, i.e. the chain pitch P, remains constant over the entire length of the anti back bend driving chain 1, even when the chain is being deflected by the chain wheel 16. The chain wheel 16 has a pitch circle diameter D, i.e. the diameter of the chain wheel between the hinge pins 6 which are in engagement with the chain teeth 17.

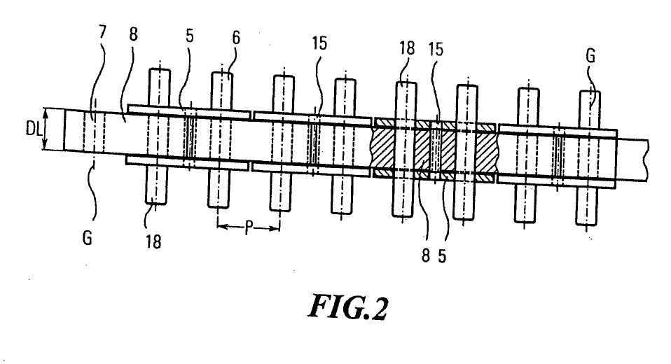

FIG. 2 shows a top view of the anti back bend driving chain 1 according to the present disclosure in which a section through the driving chain 1 is shown along an outer chain link 3. The hinge pins 6 extend through the outer link plates 5 and the inner link plates 8 along the chain hinge axis G through the inner and outer chain links 2, 3. The inner link plate 8, which defines the inner chain link 2, has a thickness DL, which is a multiple of the thickness of the outer link plates 5. In the case of this embodiment of the anti back bend driving chain 1, the hinge pins 6 protrude beyond the outer surfaces of the outer link plates 5 on both sides of said the outer link plates 5 of the outer chain link 3. The projecting length 18 of the hinge pin 6 serves to drive the anti back bend driving chain 1 by a suitably implemented chain wheel 16 in the pitch circle diameter D of the chain pitch P of the driving chain 1. The locking pin 15 extends between the two outer link plates 5, said locking pin extending essentially through the outer link plates 5 without projecting beyond the outer surfaces thereof. The locking pin 15 can be fixedly connected to the outer link plates 5 in the outer chain link e.g. by force fitting or welding.

In addition to the embodiment shown in FIG. 2, in which the hinge pins protrude beyond the outer surfaces of the outer link plates 5 on both sides thereof, an embodiment of an anti back bend driving chain 1 is also imaginable in which the projecting length 18 of the hinge pin 6 extends beyond the outer link plates 5 on only one side of the outer chain link 3. Also in the case of this embodiment the projecting length 18 engages with a suitably implemented chain wheel 16; although the anti back bend chain 1 may then be guided less effectively, the complexity and, consequently, the costs in their entirety will be reduced.

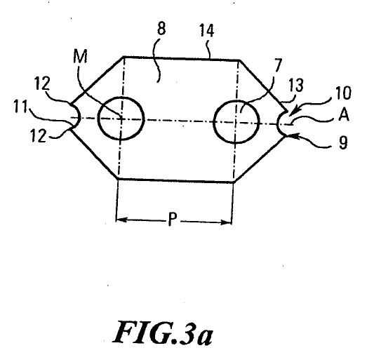

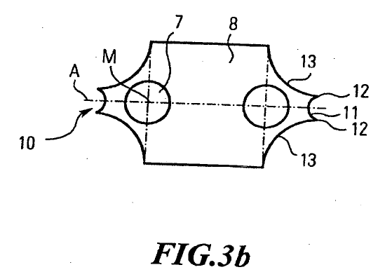

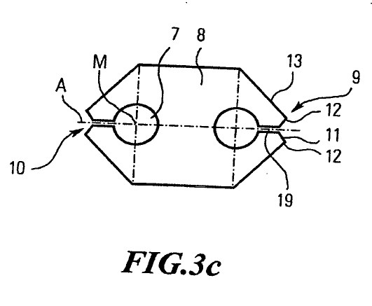

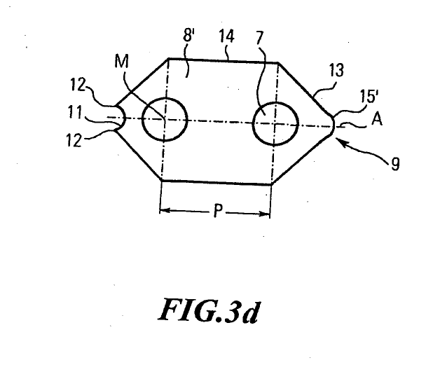

FIG. 3a shows an enlarged side view of the inner link plate 8 of the anti back bend driving chain 1 according to FIGS. 1 and 2. This view shows clearly the two hinge openings 7 provided in the inner link plate 8 and used for accommodating the hinge pin 6 with the chain pitch P that corresponds to the distance between the centres M of the hinge openings 7 and of the associated hinge pins 6, respectively. The lateral edges 14 of the inner link plate 8 extend along the pitch P, i.e. parallel to the centre line between the centres M of the hinge openings 7, on the outer contour of the inner link plate 8. The lateral edges 14 are laterally followed by the end-face side flanks 13, which extend at an oblique angle relative to said lateral edges 14 in the direction of the locking means 10 on the end face 9 of the inner link plate 8. In addition, said FIG. 3a clearly shows the structural design of the locking means including the locking recess 11, which is located centrally on the longitudinal axis A of the chain; also the longitudinal axis A of the chain extends through the centres M of the hinge openings 7. The locking recess 11 is semicircular in shape, the respective circular segment extending only over a circular segment angle of approx. 80°. Two locking projections 12 are provided between the locking recess 11 and the end-face side flanks 13 on either end face 9 of the inner link plate 8, said locking projections 12 projecting relative to a central portion of the locking recess 11; the locking-projection inner portions, which face the locking recess 11, define simultaneously the outer portions of said locking recess 11.

FIG. 3b shows another embodiment of an inner link plate 8 for the anti back bend driving chain 1 according to the present disclosure shown in FIGS. 1 and 2. Other than the inner link plate shown in FIG. 3a, this inner link plate 8 is provided with concave end-face side flanks 13. These concave end-face side flanks 13 allow a very short deflection of the chain 1 and consequently a chain wheel 16 with a small pitch circle diameter Q. In addition, the concave shape of the end-face side flanks 13 leads to a change in the shape of the locking projections 12. In particular in the area of the peaks, which project beyond the locking recess 11, the concave shape of the flanks 13 reduces the width of the locking projections 12. When the whole inner link plate 8, or the area of the locking means 10 on said inner link plate 8, is made of an elastic material, the smaller width of the peaks of the locking projections 12 allows the use of a material with lower elasticity for achieving a resilient effect of the locking means or locking projections which corresponds to that achieved in the case of straight end-face side flanks 13.

FIG. 3c shows an inner link plate 8 having provided therein a spring slot 19 in both end faces, said spring slot 19 extending from the lowest point of the locking recess 11 to the hinge opening 7 thus dividing the locking means 10 at the end face 9 into two halves. The spring slot 19 extends along the longitudinal axis A of the chain. In addition to this construction, also other arrangements of the spring slot 19 in the area of the locking recess 11 as well as in the area of the end-face side flanks can be provided for improving or establishing the resilient effect of the locking means; depending on the requirements to be fulfilled, these spring slot arrangements need not extend up to the hinge opening 7.

Other than the inner link plates 8 shown in FIG. 3a to 3c, the inner link plate 8′ of FIG. 3d is provided for use with a further embodiment of an anti back bend driving chain 1 according to the present disclosure. In contrast to the hitherto described embodiments, the end faces 9 of the inner link plate 8′ are implemented in different ways in the direction of the longitudinal axis A of the chain. One end face 9 comprises, as has been the case up to now, a locking recess 11 and two adjoining locking projections 12, whereas the second end face is provided with a locking pin 15′. This locking pin 15′ is, like the locking recess 11, arranged centrally on the longitudinal axis A of the chain. The end-face side flanks 13 on the second end face merge directly with the locking pin 15′. The locking pin 15′ is semicircular in shape or it has the shape of a circular segment, the circular segment angle lying preferably between 120° and 180°. The locking pin 15′ is implemented such that it fits into the locking recess 11 of the neighboring inner link plate 8′ in the driving chain 1 so as to stiffen and arrest, respectively, the chain hinges 4 of the chain. All the other features of this additional inner link plate 8′, which are here not described in detail, are identical with the features of the above-described link plates 8 or they produce at least the same effect.

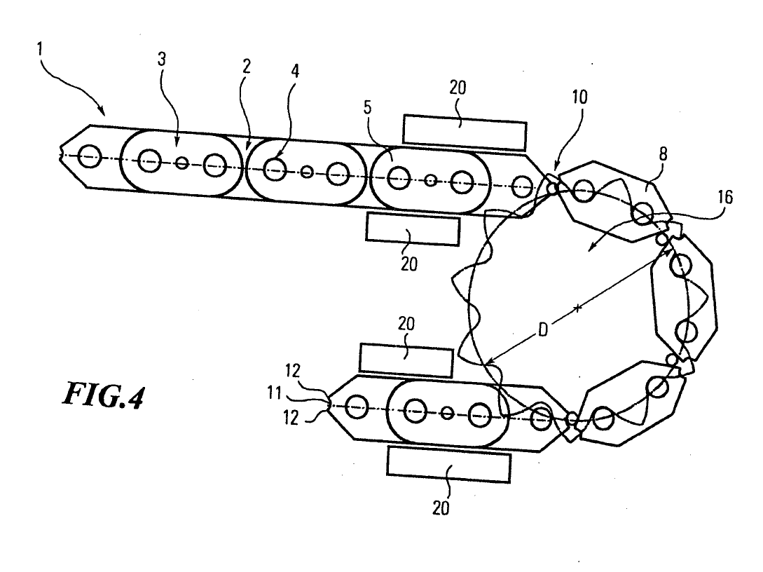

FIG. 4 shows once more the chain drive with the anti back bend driving chain 1, which has already been shown in FIG. 1, the outer link plates 5 being here cut off in the area of the chain wheel 16 so as to elucidate the operative principle of the locking means 10. In the inlet and outlet areas of the chain wheel 16, guide means 20 are provided on either side of the anti back bend driving chain 1. Depending on the position of the inner and outer chain links 2, 3 on the chain wheel 16, the locking means 10 for the respective chain hinge 4 is still locked, has already been unlocked, or is in the process of being locked or unlocked. The guide means reliably guide the chain 1 to the point of engagement with the chain wheel 16 and they simultaneously serve as a counter bearing for allowing reliable-locking and unlocking of the locking means 10.

In the following, the mode of operation of the anti back bend driving chain and of an anti back bend chain drive, will be explained in detail, making reference in particular to FIG. 4.

In an anti back bend chain 1 according to the present disclosure, the inner chain links 2 and the outer chain links 3 follow one another in alternating succession, each individual chain hinge 4 being adapted to be locked and/or unlocked by a single locking means 10. Each locking means 10 is defined by the locking recess 11, which is provided on the inner-link-plate end face 9 associated with the chain hinge 4 and which is followed by the adjoining locking projections 12, and by the locking pin 15 in the outer chain link 3. The same lacking pin 15 also serves, for the second locking means 10 associated with an outer chain link 3, as a counter bearing for the locking projection 12, and, in the locked condition, it is accommodated in the locking recess 11 of the next inner link plate 8. In the inlet and outlet areas of the chain wheel 16, the anti back bend driving chain 1 is guided and supported by guide means provided on both sides; the guide means 20, which are provided on both sides of the driving chain 1, can have different lengths and they can be arranged at different positions.

When the chain wheel 16 engages the anti back bend driving chain 1, the locking means 10, which, when seen in the direction of movement of the chain, represents the first of the two locking means formed on a locking pin 15, will first be released due to the fact that the inner chain link 2 will be entrained by the chain wheel 16 and pivoted about the associated chain hinge 4. The pivoting of the chain hinge 4 causes in said locking means 10 a curved transverse movement of the locking recess 11 and of the locking projections 12 on the inner link plate 8, whereby the locking projections 12, which overlap the locking pin 15, will resiliently move past said locking pin 15 and the locking means 10 will be unlocked. As soon as the chain wheel 16 continues its movement, also the second locking means 10 on said locking pin 15 will be released due to the fact that the outer chain link 3 is pivoted about the next chain hinge 4 and the locking pin 15 executes a curved transverse movement relative to the locking recess 11 and the locking projections 12 whereby the associated chain hinge 4 will be unlocked. In the course of this process, the guide means 20 prevents the chain links 2, 3 from swerving due to the force of the curved transverse movement which acts at right angles to the longitudinal axis A of the chain. The two locking means 10, which are formed on a locking pin 15, with the adjoining inner link plates 8 are adapted to be locked and unlocked independently of one another, the end faces 9 of the adjoining inner link plates 8 being not in contact with one another.

On the opposite side of the chain wheel 16 the chain hinges 4 are, if necessary, locked in a reverse sequence of effects so as to form a stiffened driving chain 1. Due to the rotation of the chain wheel 16 in combination with the effect produced by the guide means 20, the locking means 10 of the chain hinges 4 are locked; in the course of this process, the locking projection 12, which is in engagement with the locking pin 15, deforms elastically due to the transverse forces acting thereon; in spite of the fact that the locking projection 12 protrudes beyond the locking pin 15, it moves past said locking pin 15 until the latter is positioned in the locking recess 11.

In the locked condition, the anti back bend chain 1 has anti back bend properties with regard to both pivoting regions of the chain hinge 4. In addition, a transmission of thrust as well as a transmission of tractive forces is possible. In the locked condition, the locking means 10 is essentially forcefree, since the locking pin 15 is positively held at its position primarily due to the fact that it overlaps with the lacking projection 12. Thrust forces as well as tractive forces are therefore primarily transmitted via the chain hinges 4. In the case of a conventional half inch chain, i.e. an anti back bend driving chain 1 having a pitch P of approx. 12.7 mm, tensile loads of 500 N are possible. The locking means 10 is also forcefree in the fully unlocked condition, since the locking pin 15 is located outside of the locking projection 12 in the area of the end-face side flanks 13 without touching these side flanks or transmitting a force thereto.

The resiliently lockable and/or unlockable locking means is, in the embodiments described, based on the resilience and/or the movability of the locking projections 12, or of the locking projection 12 cooperating with the locking pin 15. A resilience of the locking projection 12 can be achieved by the use of a suitable material for the inner chain link 2 and the inner fink plate 8, such suitable materials being primarily plastic materials. In addition to the possibility of producing the inner link plate 8 from a single plastic material having a suitable resilience, it is also possible to produce, in a two-component injection molding process, only the area of the locking means 10, or of the locking projection 12 related to the locking pin 15, from a suitably resilient plastic material, whereas most of the inner link plate 8, in particular also the area of the hinge openings 7 which are subjected to the tractive forces and the thrust forces, can consist of a suitably stiff material.

In addition to or instead of a resilience realized by the respective material selected, the resilient locking and/or unlocking can also be achieved by means of a spring slot 19 through which the locking projection 12 can be moved relative to the rest of the inner link plate 8, so as to realize a relative movement of the locking projections 12, which project beyond the locking pin 15, past the locking pin 15. Although a spring slot 19 which extends from the locking recess 11 up to the hinge opening 7 of the inner link plate 8 fundamentally allows the maximum movability of the locking projection 12, this structural design weakens the hinge opening 7 so that, especially when tractive forces occur, the spring slot 19 may undergo unintentional enlargement and this may result in a weakening of the driving chain 1 itself.

In addition to the above-described variant, in the case of which each chain hinge 4 can be stiffened or arrested by a separate locking means 10, two respective chain hinges 4, which are associated with an outer chain link 3, are stiffened by one locking means 10 in the case of an anti back bend driving chain 1 according to the present disclosure, which is provided with the inner fink plates 8′ that are shown in FIG. 3d. Other than in the case of the hitherto described embodiments, a locking pin 15, which extends between the outer link plates 5 of the outer chain link 3, can be dispensed with in the case of such an anti back bend driving chain 1. One end face 9 of the inner link plate 8 is here, however, provided with a locking recess 11 and two locking projections 12 and the second end face is provided with a locking pin 15′ which is fixedly arranged on the inner link plate. The locking pin 15′ arranged on the inner link plate 8 cooperates in a corresponding manner with the locking projections 12 and the locking recess 11 of the subsequent inner chain link 2 and arrests, in the locked condition, both adjoining chain hinges 4.

We claim:

1. An anti back bend driving chain, comprising alternating first and second chain links interconnected via a respective chain hinge (4) and pivotable relative to one another about a chain hinge axis (G), at least one means for stiffening or arresting the chain hinges (4) at least temporarily, the means for stiffening or arresting comprising a resiliently lockable and/or unlockable locking means (10), the locking means (10) being adapted to be locked and/or unlocked by pivoting the chain links relative to one another.

2. An anti back bend driving chain (1) according to claim 1, wherein the locking means (10) is implemented symmetrically with respect to the longitudinal axis (A) of the chain in the direction of movement of the chain.

3. An anti back bend driving chain (1) according claim 1, wherein the locking means (10) comprises a locking projection (12) which is resiliently deformable during locking and/or unlocking.

4. An anti back bend driving chain (1) according to claim 3, wherein the locking means (10) comprises a locking pin (15) and a locking recess (11), the locking pin (15) being adapted to be received in said locking recess (11).

5. An anti back bend driving chain (1) according to claim 4, wherein each of said first chain links is provided with a locking recess (11) on either end face (9) in the direction of movement of the chain, the locking recess (11) being adapted to receive therein a locking pin (15), and with at least one locking projection (12), and that each of the second chain links is provided with at least one locking pin (15).

6. An anti back bend driving chain (1) according to claim 4, wherein each of the first chain links is provided with a locking recess (11) and at least one lacking projection (12) on a first end face (9) in the direction of movement of the chain and with a locking pin (15) on a second end face in the direction of movement of the chain, the locking pin (15) fitting into the locking recess (11) of a neighboring first chain link.

7. In anti back bend driving chain (1) according to claim 4, wherein the lacking projection (12) and the locking pin (15) overlap in the locked condition.

8. An anti back bend driving chain (1) according to claim 4, wherein the locking projection (12), the locking recess (11) and the locking pin (15) have longitudinal axes which extend parallel to the chain hinge axis (G).

9. An anti back bend driving chain (1) according to claim 4, wherein the pivoting of the chain links for locking and/or unlocking the locking means (10) causes the locking recess (11) and the locking pin (15) to move relative to one another in a curved transverse movement relative to the longitudinal axis (A) of the chain, the locking pin (15) being adapted to be locked in and/or unlocked from the locking recess (11) due to said transverse movement.

10. An anti back bend driving chain (1) according to claim 1, wherein the first chain links are implemented as inner chain links (2) and that the second chain links are implemented as outer chain links (3).

11. An anti back bend driving chain (1) according to claim 10, wherein the outer chain link (3) comprises two outer link plates (5), two hinge pins (6) which extend through said outer link plates (5), and at least one locking pin (15).

12. An anti back bend driving chain (1) according to claim 11, wherein the locking pin (15) extends between the outer link plates (5) and that, when seen in the direction of the longitudinal axis (A) of the chain, it is arranged centrally on said outer link plates (5).

13. An anti back bend driving chain (1) according to claim 10 the inner chain link (2) comprises at least one inner link plate (8) and that the inner link plate (8) is provided with a locking recess (11) and with at least one locking projection (12).

14. An anti back bend driving chain (1) according to claim 13, wherein the at least one inner link plate (8) is produced from plastic material.

15. An anti back bend driving chain (1) according to claim 13 wherein the thickness (DL) of the inner link plate (8) corresponds to 3 to 8 tinges the thickness of the outer link plate (5), preferably to 4 to 6 times the thickness of said outer link plate (5).

16. An anti back bend driving chain (1) according to claim 4, wherein the locking means (10) comprises at least one spring slot (19), said spring slot (19) being formed in the first chain link and cooperating with the locking projection (12).

17. An anti back bend driving chain (1) according to claim 1, wherein each chain link (4) comprises a hinge pin (6) which extends through at least one hinge opening (7) in the chain links, the hinge pin (6) projecting on at least one side of the chain links for engagement with a chain wheel (16).

18. An anti back bend chain drive, in particular for driving automated gate or door drives, comprising an anti back bend driving chain (1) according to claim 1, and at least one chain wheel (16) for driving said anti back bend driving chain (1).

19. An anti back bend chain drive according to claim 18, and a guide means (20) for guiding and supporting the anti back bend driving chain (1) at least during the locking and/or unlocking process.

20. An anti back bend chain drive according to claim 19, wherein the guide means (20) has a length which corresponds to approximately 1 to 3 times the chain pitch length (P).

21. An anti back bend chain drive according to claim 18, wherein the diameter (d) of the chain wheel (16) is smaller than approximately 4 times the chain pitch (P) of the anti back bend driving chain (1).

22. An anti back bend chain drive according to claim 20, wherein the length of the guide means (20) corresponds to approximately 2 times the chain pitch length (P).

23. An anti back bend chain drive assembly according to claim 21, wherein the diameter (D) is smaller than approximately 3 times the chain pitch (P).
